(19) United States
(12) Patent Application Publication
(10) Pub. No.: US 2022/0186970 A1
(43) Pub. Date: Jun. 16, 2022

(54) METHOD AND A DEVICE FOR SENSORLESS ASCERTAINING OF VOLUME FLOW AND PRESSURE

(71) Applicant: ebm-papst Mulfingen GmbH & Co. KG, Mulfingen (DE)

(72) Inventor: Walter EBERLE, Mulfingen (DE)

(73) Assignee: ebm-papst Mulfingen GmbH & Co. KG, Mulfingen (DE)

(21) Appl. No.: 17/437,371

(22) PCT Filed: May 14, 2020
(86) PCT No.: PCT/EP2020/063514

§ 371 Date: Sep. 8, 2021

(30) Foreign Application Priority Data
Jun. 27, 2019 (DE) 10 2019 117 339.6

(51) Int. Cl. F24F 11/77; F04D 27/00; G06N 3/08

(52) U.S. Cl. CPC F24F 11/77; G06N 3/08; F04D 27/001; F04D 27/004

(57) ABSTRACT

A method for ascertaining volume flow or pressure for controlling a ventilator, operated by an EC motor, of a specific ventilation device to a specific operating point in order to achieve and maintain a specified nominal volume flow strength or nominal pressure of the ventilation device without use of a pressure or volume flow sensor. The volume flow is ascertained by an artificial neuronal network on the basis of a sequential learning method with a number of learning steps. A linking of n artificial neurons in one or more layers is provided. At least one entry layer Pi is provided in order to process a number of I input parameters, that have a direct or indirect influence on the volume flow in the ventilation device.

### CROSS-REFERENCE TO RELATED APPLICATIONS

This application is a 371 U.S. National Phase of International Application No. PCT/EP2020/063514, filed May 14, 2020, which claims priority to German Patent Application No. 10 2019 117 339.6, filed Jun. 27, 2019. The entire disclosures of the above applications are incorporated herein by reference.

### FIELD

The present disclosure relates to a method and a device for sensorless ascertaining of volume flow or pressure for regulating a ventilation unit fan that is operated by an EC motor.

### BACKGROUND

In order to supply fresh air and to exhaust used air in buildings and facilities with ventilation systems, it is typically necessary to use ventilation units with ventilation conduits and air ducts for the airflow. The supply air or exhaust air is conveyed in the airflow. It is moved by one or more fans of the ventilation system in order to achieve a required volume flow that is as constant as possible.

Duct lengths, duct diameters, duct materials, and also the design of other parts of a ventilation system such as the design of an air outlet are determined very individually by the manufacturer of the ventilation unit. Such design features and influence factors of the application are not generally known to a manufacturer of the fan that is used in the ventilation unit.

A ventilation system should be designed as optimally as possible based on individual conditions. The theoretical, merely calculated and required volume flows must then be maintained in actual operation. In particular, they should not deviate from the values calculated in advance and if possible, should fluctuate little if at all.

DE 10 2011 106 962 A1 has disclosed a blower for a ventilation system with a motor and an associated control unit, which uses an actual/target comparison of a motor current to control the motor so as to supply a constant quantity of air.

DE 10 2008 057 870 A1 discloses a control unit of a ventilation unit, which controls the motor of the blower to achieve the smallest possible gap between the amount of electrical power consumed and the desired electrical power according to the speed.

DE 10 2004 060 206 B3 describes a method for operating a rectifier-supplied compressor as a function of an instantaneous characteristic curve and DE 10 2005 045 137 A1 describes a method for operating a fan unit with a predetermined constant air volume or operating pressure. The fan unit has an electric motor to drive a fan impeller. Also, it has a motor control unit. The motor control unit determines the motor voltage for the operating point based on characteristic curves.

### SUMMARY

It is also known that a fan has so-called fan characteristic. The characteristic describes behavior without any control influence. In the planning of a ventilation system, a desired target volume flow of a ventilation unit is calculated based on various parameters of the specific application. If the volume flow falls below the target, too little air is supplied. It is therefore desirable to produce fans that have a steep as possible fan characteristic in their respective operating range. Thus, they are able to maintain a constant volume flow for as long as possible in the presence of a rising back pressure.

It is also already well-known from the prior art to equip fans of ventilation units with so-called EC motors. Brushless DC motors are also referred to as EC motors. Their motor windings are activated, for example, as a function of the position of a permanent magnet on a rotor. In this way, a magnetic field is generated, that is present in the rotor in a virtually ideal way. This enables a high efficiency of the EC motor. For this type of activation, though, the position of the rotor relative to the stator must be known. This can be achieved in various intrinsically known ways, for example, by a Hall sensor and a magnet. In comparison to other motors, considerable savings in power consumption can be achieved with an EC motor. EC motors frequently have an internal control, but it only keeps the power consumption of the EC motor approximately constant. When used in ventilation technology, the fan characteristic of EC motors is disadvantageous. Starting from a volume flow intensity in free-blowing mode, the volume flow of fans, that are operated with an EC motor, decreases continuously as back pressure increases. The fan characteristic thus lacks the “desired” steepness.

Thus, it is known, when using an EC motor in a ventilation unit, to provide a more elaborate control unit in order to keep the volume flow as constant as possible in the presence of a varying back pressure. It is customary to use sensors so as to permit one sensor to measure sensor data and based on the data, to selectively change the speed of the fan as the back pressure changes in order to maintain the predetermined target volume flow or target pressure.

It is also known from the prior art to use alternative or additional volume flow sensors. The use of such sensors, however, has the disadvantage of a high technical cost, particularly since in typical ventilation applications, very low values of back pressure occur as compared to atmospheric pressure. Thus, it is necessary to use very sensitive sensors for pressure or volume flow. The use of sensors is thus not only expensive and complex, but also subject to other disadvantages such as sensor failures, sensor contamination, and the like.

in addition, in the case of volume flows that must be precisely controlled in laboratory applications, it is necessary to use additional sensors in order to measure the volume flow. For example, thermal sensors are mounted on components that require cooling. If the temperature rises, then the speed of the fan is increased without knowing the precise influence on the volume flow or pressure in this case.

It is therefore desirable to achieve a technical solution or a method for sensorless regulation of a ventilation unit fan that is operated by an EC motor at a specific volume flow and/or operating point, in order to achieve and maintain a predetermined target volume flow intensity or a target pressure.

An object of the present disclosure, therefore, is to overcome the above-mentioned disadvantages of the prior art and propose a simple and expensive achievable solution for sensorless regulation of a ventilation unit fan that is operated by an EC motor at a specific volume flow, pressure, and/or operating point.

This object is achieved by a method for ascertaining the volume flow or pressure for regulating a fan of a particular ventilation unit that is operated by an EC motor at a specific operating point in order to achieve and maintain a predetermined target volume flow intensity or target pressure of the ventilation unit without using a pressure sensor or volume flor sensor comprising: determining volume flow by an artificial neural network based on a sequential learning process; providing a number of learning steps where a concatenation of n artificial neurons is provided in one or more layers, providing at least one input layer Pi; and processing a number of I input parameters that have a direct or indirect influence on the volume flow.

A fundamental concept of the disclosure relates to the sequential learning of an artificial neural network. The trained neural network is able to determine the respective current volume flow or current pressure based on input parameters. If after a sufficient training process, the neural network is completely trained, then it is possible to determine the volume flow and/or pressure for this fan type and to control them during operation.

The relevant parameters from which the volume flow (or pressure) is determined thus constitute the input values of the neural network. The relevant parameters are those parameters that have a physical influence on the volume flow. These parameters are, for example, the coil current—or if this cannot be measured, the current that flows in the intermediate circuit of the EC motor of the fan, the speed of the fan, and the current degree of excitation of the motor. If the neural network must determine the volume flow or the pressure, even with a fluctuating input voltage or intermediate circuit voltage or at different temperatures, then the network input voltage and the current temperature are also used as input parameters. If the volume flow must be determined independently of the current air pressure, it can also be used as an input variable. The number of input parameters dictates the number of input neurons of the artificial neural network.

According to the disclosure, a method has been developed for ascertaining the volume flow or pressure to regulate a particular ventilation unit fan that is preferably operated by an EC motor at a specific operating point in order to achieve and maintain a predetermined target volume flow intensity (or pressure) of the ventilation unit without using a pressure sensor or volume flow sensor. The volume flow is determined by of an artificial neural network based on a sequential learning process. The process includes a number of learning steps where a concatenation of n artificial neurons is provided in one or more layers. At least one input layer Pi is provided in order to process a number of i input parameters. The parameters have a direct or indirect influence on the volume flow in the ventilation unit.

It is particularly advantageous if first, a quantity of actual measurement data of physical variables of the fan, over its entire operating range, is detected. The measurement data include at least the i input parameters and the output parameter or parameters to be determined. The artificial neural network is trained with these input and output parameters based on a predetermined algorithm that has several variables. The variables of the algorithm are determined in each calculation sequence of the neural network. Thus, the output of the neural network increasingly corresponds to the measured data as much as possible.

It is also advantageous if the artificial neural network is composed of a feedforward network. In particular, the artificial neural network has an input layer Pᵢ, at least one intermediate layer Z with the activation function f_{z}, and an output layer A with the activation function fₒ.

In a particularly advantageous embodiment of the disclosure, the intermediate layer Z has a selectable number N of neurons. The number N is selectable as a function of the number of input values and the desired degree of ascertainment precision.

It is also advantageous if each neuron of the intermediate layer Z outputs its status to the output layer A via the activation function f_{z}.

In a likewise advantageous embodiment of the disclosure, the activation function f_{z} preferably uses a hyperbolic tangent function as follows:

Outⱼ=f_{z}(bⱼ+Σₖ₌₁ⁱwⱼₖPₖ)

where:
Outⱼ is the output of the j^{th} neuron of the intermediate layer;
f_{z} is the activation function of the intermediate layer Z;
wⱼₖ is the weighting of the k^{th} input neuron on the j^{th} neuron of the intermediate layer;
bⱼ is the bias of the j^{th} neuron of the intermediate layer; and
i is the number of input neurons.

It is also advantageous if the output layer A consists of one or two neurons, with a linear function being used as the activation function for the output neuron

A=fₒ(bₒ+Σₖ₌₁^{N}qₖOutₖ)

where:
A is the output of the neuron;
fₒ is the activation function of the output layer;
qₖ is the weight of the k^{th} neuron of the intermediate layer Z on the output neuron;
bₒ is the bias of the output neuron; and
N is the number of neurons of the intermediate layer.

In this case, it is advantageous if the parameters bⱼ, wⱼₖ, qₖ, and bₒ are incrementally adapted in each calculation sequence in order to train the neural network until the output neurons, determined by the neural network, represent a volume flow and/or pressure, that corresponds to the actual measured volume flow and/or pressure, with a deviation that is less than a predetermined maximum permissible deviation. In other words, the neural network is sufficiently trained in order to sensorlessly ascertain the desired variables with enough precision.

Another aspect of the present disclosure relates to a device for carrying out a method of the kind described above. The device includes a fan in a ventilation unit, a number of sensors for detecting input and output parameters, a measuring device for determining the input and output parameters based on physical measurement data detected by the sensors, and a data processing unit with an artificial neural network of a predetermined topology. The data processing unit has at least one interface to transmit the detected input parameters to at least the input layer. The output parameters are transmitted to the data transmission unit.

The drawings described herein are for illustrative purposes only of selected embodiments and not all possible implementations, and are not intended to limit the scope of the present disclosure.

Other advantageous modifications of the disclosure are disclosed in the dependent claims and will be presented in greater detail below together with the description of the preferred embodiment of the disclosure based on the figures.

### DRAWINGS

FIG. 1 is a schematic view of a concept of the implementation of an artificial neural network;

FIG. 2 is a schematic view of an error curve showing the relative error in the ascertainment of the volume flow in a first exemplary embodiment; and

FIG. 3 is a schematic view of an error curve showing the relative error in the ascertainment of the volume flow in an alternative exemplary embodiment.

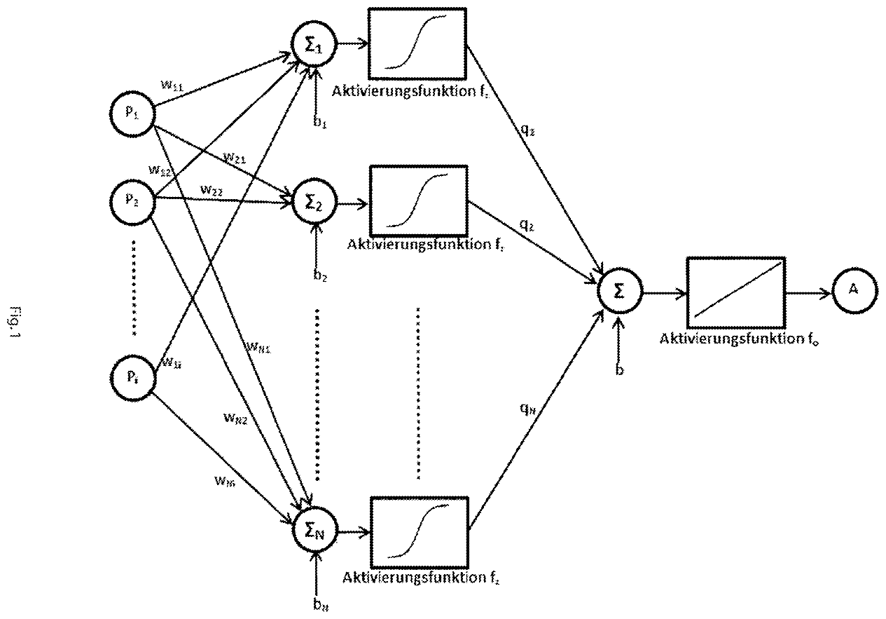

In the following, the disclosure will be explained in greater detail based on the two exemplary embodiments with reference to FIGS. 1 to 3. Reference numerals that are the same in the figures indicate equivalent structural and/or functional features.

FIG. 1 shows a schematic view of a concept of the implementation of an artificial neural network, which is embodied as a feedforward network. The artificial neural network has an input layer Pᵢ, an intermediate layer Z with its activation function f_{z}, and an output layer A with an activation function fₒ.

In the network topology, the weighted parameters wⱼₖ, namely w₁₁; w₁₂, w₂₁, w₂₂, . . . are also shown. Each one indicates the weighting of the k^{th} input neuron on the j^{th} neuron of the intermediate layer. The variables b, b₁, b₂ . . . bₙ indicate the bias neurons, with bⱼ indicating the j^{th} bias neuron of the intermediate layer.

In the output layer, A indicates the output of the output neuron. This corresponds to the determined volume flow. The activation function fₒ of the output layer is also shown. Additionally shown is the weight qₖ of the k^{th} neuron of the intermediate layer Z on the output neuron.

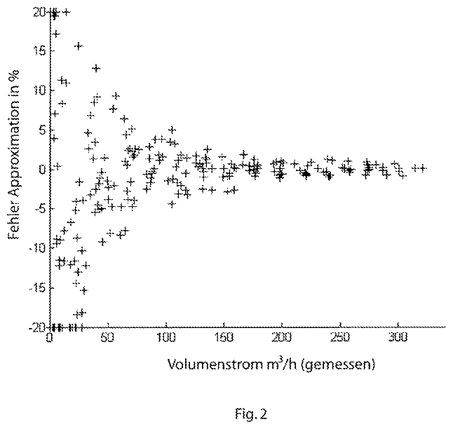

FIG. 2 is an error curve showing the relative error in the ascertainment of the volume flow in a first exemplary embodiment. It has a network topology with two input neurons. One input neuron is for the current and one input neuron for the rotation speed.

In this example, the intermediate layer includes 10 neurons and the output layer consisted of one neuron. A hyperbolic tangent is used as the activation function of the intermediate layer f_{z} and a linear function is used as the activation function of output layer.

The relative error is the error between the approximated and measured volume flow divided by the measured volume flow in % plotted over the measured volume flow (errors greater than 20% were limited to 20%). It should be noted that the error becomes progressively smaller due to the relative error (approximated error−measured error).

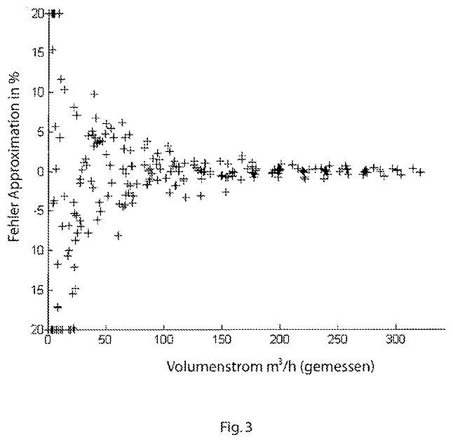

FIG. 3 is an error curve showing the relative error in the ascertainment of the volume flow in an alternative exemplary embodiment. It has a network topology with three input neurons. One input neuron is for the current, one input neuron is for the rotation speed, and one additional neuron is for the current degree of excitation of the motor.

In this example, the intermediate layer includes 15 neurons and the output layer includes one neuron. As in the example in FIG. 2, a hyperbolic tangent is used as the activation function of the intermediate layer f_{z} and a linear function is likewise used as the activation function of the output layer.

The embodiment of the disclosure is not limited to the preferred exemplary embodiments disclosed above. On the contrary, there are a number of conceivable variants that make use of the presented solution, even in fundamentally different embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-10. (canceled)

11. A method for ascertaining the volume flow or pressure for regulating a fan of a particular ventilation unit that is operated by an EC motor at a specific operating point in order to achieve and maintain a predetermined target volume flow intensity or target pressure of the ventilation unit without using a pressure sensor or volume flow sensor comprising:
determining the volume flow by an artificial neural network based on a sequential learning process;
providing a number of learning steps where a concatenation of n artificial neurons is provided in one or more layers;
providing at least one input layer Pi; and
processing a number of input parameters, which have a direct or indirect influence on the volume flow in the ventilation unit.

12. The method according to claim 11, further comprising:
first detecting a quantity of actual measurement data of physical variables of the fan over its entire operating range;
determining, from the measurement data, at least the I input parameters and the output parameter or parameters;
training the artificial neural network with these input and output parameters based on a predetermined algorithm that has several variables; and
determining the variables of the algorithm in each calculation sequence of the neural network so that the output of the neural network increasingly corresponds to the measured data as much as possible.

13. The method according to claim 11, wherein the artificial neural network includes of a feedforward network.

14. The method according to claim 11, wherein the artificial neural network has the input layer Pi, at least one intermediate layer Z with an activation function f_{z}, and an output layer A with the activation function fₒ.

15. The method according to claim 14, wherein the intermediate layer Z has a selectable number N of neurons, with the number N being selectable as a function of the number of input values and a desired degree of ascertainment precision.

16. The method according to claim 15, wherein each neuron of the intermediate layer Z outputs its status to the output layer A via the activation function f_{z}.

17. The method according to claim 14, wherein the activation function f_{z} y uses a hyperbolic tangent function as follows:
Outⱼ=f_{z}(bⱼΣₖ₌₁ⁱwⱼₖPₖ)
where:
Outⱼ is output of the j^{th} neuron of the intermediate layer;
f_{z} is activation function of the intermediate layer Z;
wⱼₖ is weighting of the k^{th} input neuron on the j^{th} neuron of the intermediate layer;
bⱼ is bias of the j^{th} neuron of the intermediate layer; and
i is the number of input neurons.

18. The method according to claim 14, wherein the output layer A includes of one or two neurons, with a linear function is used as an activation function for the output neuron
A=fₒ(bₒ+Σₖ₌₁^{N}qₖOutₖ)
where:
A is output of the neuron;
fₒ is activation function of the output layer;
qₖ is weight of the k^{th} neuron of the intermediate layer Z on the output neuron;
bₒ is bias of the output neuron; and
N is the number of neurons of the intermediate layer.

19. The method according to claim 17 wherein the parameters bⱼ, wⱼₖ, are incrementally adapted in each calculation sequence in order to train the neural network until the output neurons determined by the neural network represent a volume flow and/or pressure, that correspond to an actual measured volume flow and/or pressure with a deviation that is less than a predetermined maximum permissible deviation.

20. The method according to claim 18 wherein the parameters qₖ and bₒ, are incrementally adapted in each calculation sequence in order to train the neural network until the output neurons determined by the neural network represent a volume flow and/or pressure, that correspond to an actual measured volume flow and/or pressure with a deviation that is less than a predetermined maximum permissible deviation.

21. A device for carrying out a method according to claim 11, including a fan in a ventilation unit, a number of sensors for detecting input and output parameters of the fan, a measuring device for determining the input and output parameters based on physical measurement data detected by the sensors, a data processing unit with an artificial neural network of a predetermined topology; and the data processing unit has at least one interface for transmitting the detected input parameters to at least the input layer.
